(19) United States
(12) Patent Application Publication
(10) Pub. No.: US 2025/0284242 A1
(43) Pub. Date: Sep. 11, 2025

(54) ADAPTATION DEVICE, PROCESS CARTRIDGE, AND PROCESS CARTRIDGE SET

(71) Applicant: Zhuhai Pantum Electronics Co., Ltd., Zhuhai (CN)

(72) Inventors: Zhe SHAO, Zhuhai (CN); Leifeng ZHU, Zhuhai (CN); Xiangchao XIA, Zhuhai (CN)

(21) Appl. No.: 19/216,670

(22) Filed: May 22, 2025

Related U.S. Application Data
(63) Continuation of application No. PCT/CN2023/132144, filed on Nov. 16, 2023.

(30) Foreign Application Priority Data
Nov. 23, 2022 (CN) 202211470361.3

(51) Int. Cl. G03G 21/18

(52) U.S. Cl. CPC G03G 21/1867; G03G 21/1807; G03G 21/1821

(57) ABSTRACT

This application discloses an adaptation device, a process cartridge, and a process cartridge set. The adaptation device includes an electrical transmission component and a connection component. The electrical transmission component includes an input terminal and an output terminal. The output terminal is used for supplying power to an imaging component. The connection component includes a first end member and a second end member. The first end member is electrically connected to the second end member, and the second end member is used to output power. This application enables electrical connection among process cartridges through adaptation devices. It reduces the number of conductive contacts on the main body side of the image forming device, the force between the main body side and the process cartridge, the strength requirements on the main body side, and the costs.

This application is a continuation application of PCT application No. PCT/CN2023/132144, filed on Nov. 16, 2023, which claims the priority to Chinese Patent Application No. 202211470361.3, filed on Nov. 23, 2022, the contents of all of which are incorporated herein by reference in their entirety.

### TECHNICAL FIELD

The present disclosure generally relates to the field of image forming technology and, more particularly, relates to an adaptation device, a process cartridge, and a process cartridge set.

### BACKGROUND

Image forming devices usually use process cartridges to form images. According to imaging principles of the process cartridge, during an imaging process of the process cartridge, different voltages need to be applied to a charging roller, a photosensitive drum, a developing roller, and other components at the process cartridge. Therefore, during operation of an image forming device, each process cartridge is required to be electrically connected to a main body side of the image forming device.

Existing solutions for electrically connecting a process cartridge to the main body side of an image forming device is that each process cartridge independently contacts and conducts electricity with the main body side of the image forming device. Take the electrical connection scheme of a general process cartridge (e.g., a toner cartridge waste toner bin) as an example. Each process cartridge includes a conductive end cap of a waste toner bin, a charging roller, a photosensitive drum (e.g., an OPC photosensitive drum), a photosensitive drum conductive sheet, and a charging roller conductive sheet. Among them, the photosensitive drum conductive sheet and charging roller conductive sheet are two elastic thin steel sheets, which are respectively installed on the conductive end cover of the waste toner bin, and are respectively in contact with corresponding conductive contacts on the main body of the image forming device. The charging roller is provided with a charging roller steel shaft. The charging roller steel shaft contacts the charging roller conductive sheet to realize electrical connection between the main body of the image forming device and the charging roller. The photosensitive drum is in contact with the photosensitive drum conductive sheet to realize the electrical connection between the main body of the image forming device and the photosensitive drum.

Therefore, the photosensitive drum and charging roller of each process cartridge are provided with corresponding conductive contacts on the main body of the image forming device. Image forming devices, such as color laser printers, usually have four process cartridges. Thus, a color laser printer requires at least eight contacts on its main body to conduct electricity to the photosensitive drum and charging roller, respectively.

The above-mentioned existing electrical connection scheme between a process cartridge and the main body side of an image forming device may ensure good electrical conductivity. However, many conductive contacts need to be provided on the main body side of the image forming device, and the structure is complex and the cost is high. In addition, each conductive contact may be subject to an elastic contact force with the conductive sheet of the process cartridge. As a result, the main body side of the image forming device will be subject to a larger force. This requires a very good strength requirement on the main body side of the image forming device, which will also increase the cost.

### CONTENTS OF INVENTION

In order to overcome the above-mentioned problems in the prior art, the main purpose of the present application is to provide an adaptation device that may reduce the cost of image forming devices.

In order to achieve the above objectives, the present application specifically adopts the following technical solutions.

The present application provides an adaptation device used at a process cartridge. The adaptation device is detachably installed at the process cartridge and used to electrically connect an imaging component of the process cartridge. The adaptation device includes an electrical transmission component. The electrical transmission component includes an input terminal and an output terminal. The input terminal and output terminal are electrically connected. The output terminal is used to provide power to the imaging component.

The adaptation device further includes a connection component. The connection component includes a first end member and a second end member. The first end member is electrically connected to the second end member, and the second end member is used to output power.

At least one of the first end member and the input terminal is used to connect to an external power supply.

When the adaptation device is used to transmit power to the imaging component at the process cartridge, the input terminal of the electrical transmission component is electrically connected to at least one of the first end member and the second end member.

The present application also provides an image forming device. The image forming device includes a body and a process cartridge as described above, or a body and a process cartridge set containing process cartridges as described above. The process cartridge or process cartridge set may be detachably installed at the body. Compared with the prior art, an adaptation device of the present application includes an electrical transmission component and a connection component. The electrical transmission component includes an input terminal and an output terminal. The output terminal is used to provide power to an imaging component. The connection component includes a first end member and a second end member. The first end member is electrically connected to the second end member. The second end member is used to output power, and at least one of the first end member and the input terminal is used to access an external power supply. When the adaptation device is installed at the process cartridge, if multiple process cartridges are combined, the adaptation devices provided at each process cartridge may be connected end to end. As such, process cartridges may be electrically connected through the adaptation devices. Therefore, the number of conductive contacts that need to be provided on the main body side of the image forming device may be reduced. Further, it reduces the force between the main body side of the image forming device and the process cartridge, reduces the strength requirements on the main body side of the image forming device, and also reduces the costs.

### BRIEF DESCRIPTION OF THE DRAWINGS

In order to explain embodiments of the present application or technical solutions in the prior art more clearly, drawings needed to be used in the description of the embodiments or the prior art will be briefly introduced below. Obviously, drawings in the following description are some embodiments of the present application. For those of ordinary skill in the art, other drawings can also be obtained based on these drawings without exerting creative labor.

FIG. 1 is a schematic structural diagram of an adaptation device provided for embodiments of the present application;

FIG. 2 is a schematic structural diagram of the adaptation device shown in FIG. 1 installed at a process cartridge;

FIG. 3 is a schematic structural diagram of an adaptation device provided for another embodiment of the present application;

FIG. 4 is a schematic structural diagram of the adaptation device shown in FIG. 3 installed at a process cartridge;

FIG. 5 is a schematic structural diagram of a process cartridge set provided for embodiments of the present application;

FIG. 6 is a schematic structural diagram of a process cartridge set provided for another embodiment of the present application;

FIG. 7 is a schematic structural diagram of a process cartridge set provided for another embodiment of the present application;

FIG. 8 is a cross-sectional view of an adaptation device installed at a process cartridge according to another embodiment of the present application;

FIG. 9 is a schematic structural diagram of a process cartridge set provided for another embodiment of the present application;

FIG. 10 is a schematic structural diagram of a process cartridge set provided for another embodiment of the present application;

FIG. 11 is a schematic structural diagram of an image forming device provided for embodiments of the present application;

FIG. 12 is a schematic structural diagram of conductive terminals provided on the main body shown in FIG. 11;

FIG. 13 is a schematic structural diagram of a process cartridge set shown in FIG. 11; and

FIG. 14 is a schematic structural diagram of an image forming device provided for another embodiment of the present application.

### DETAILED DESCRIPTION

In order to make the purpose, technical solutions, and advantages of the present application clearer, the present application will be further described in detail below in conjunction with the drawings and examples. It should be understood that the specific embodiments described here are only used to explain the present application and are not used to limit the present application.

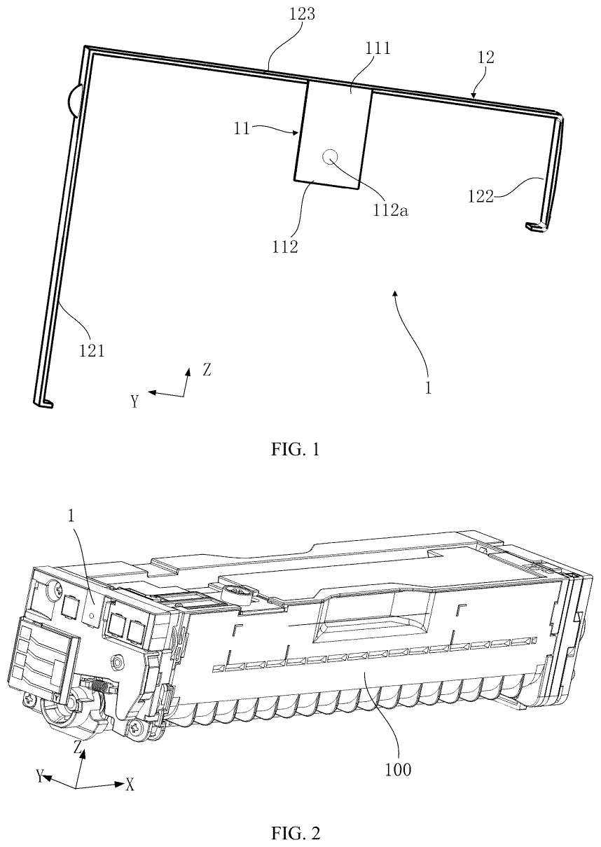

Referring to FIGS. 1 and 2, an adaptation device 1 is detachably mounted on a process cartridge 100 and used to electrically connect imaging components of two adjacent process cartridges 100. The adaptation device 1 includes an electrical transmission component 11 and a connection component 12. The electrical transmission component 11 is electrically connected to an imaging component for outputting power to the imaging component. The connection component 12 is used to transmit power outside the current process cartridge 100.

Specifically, the electrical transmission component 11 includes an input terminal 111 and an output terminal 112. The input terminal 111 and output terminal 112 are electrically connected. The connection component 12 includes a first end member 121 and a second end member 122. The input terminal 111 may be used to connect to an external power supply. The output terminal 112 is electrically connected to the imaging component and used to transmit the power received by the input terminal 111 to the imaging component to provide power to the imaging component. The first end member 121 and second end member 122 are electrically connected, and at least one of the first and second end members 121 and 122 is electrically connected to the input terminal 111. The first end member 121 may be used to connect to the external power supply, while the second end member 122 may be used to output power to the outside of the current process cartridge. The external power supply is a power supply output by other process cartridges or a power supply output by an image forming device.

Further, the connection component 12 also includes a connection member 123. The two ends of the connection member 123 are connected to the first end member 121 and second end member 122, respectively, and the length extension direction of at least one of the first end member 121 and second end member 122 is perpendicular to the length extension direction of the connection member 123 (i.e., the Y direction in FIG. 1). In this embodiment, the length extension directions of the first end member 121 and the second end member 122 are both perpendicular to the length extension direction of the connection member 123. The input terminal 111 of the electrical transmission component 11 is connected to the connection member 123. When the adaptation device 1 is installed at the process cartridge 100, the output terminal 112 of the electrical transmission component 11 is electrically connected to the imaging component. Both the first end member 121 and second end member 122 extend along a direction perpendicular to the width extension direction of the process cartridge. The shortest connection line between the first end member 121 and second end member 122 is parallel to the width extension direction of the process cartridge (i.e., the Y direction in FIG. 2). It facilitates electrical connection between the two adaptation devices 1 provided in two adjacent process cartridges 100, thereby achieving electrical connection between imaging components of the two adjacent process cartridges 100. In addition, the shortest connection line between the first end member 121 and second end member 122 is perpendicular to the length extension direction of the first end member 121 and the length extension direction of the second end member 122, respectively.

In this embodiment, the adaptation device 1 further includes a fixing part. The electrical transmission component 11 is detachably connected to the connection component 12 through the fixing part. The length extension direction of the electrical transmission component 11 (i.e., the Z direction in FIG. 1) is perpendicular to the length extension direction of the connecting component 12 (i.e., the Y direction in FIG. 1). It can be understood that in other embodiments, the electrical transmission component 11 may also be integrally formed with the connection component 12.

In order to facilitate the connection between the output terminal 112 and the imaging component, the output terminal 112 is also provided with an accommodation part. The accommodation part is set as a through hole 112a. During assembly, each adaptation device 1 is installed at a process cartridge 100, respectively. The through hole 112a is sleeved on the imaging component, so that the output terminal 112 is electrically connected to the imaging component of the process cartridge 100.

In some embodiments, the process cartridge 100 further includes a conductive sheet. The conductive sheet is connected to an end part of the imaging component. The output terminal 112 of the electrical transmission component 11 is used to electrically connect with the conductive sheet, thereby achieving electrical connection between the electrical transmission component 11 and the imaging component.

When each process cartridge 100 is electrically connected, adaptation devices 1 are installed at the process cartridges 100, the output terminals 112 of the electrical transmission components 11 are connected to the imaging components of corresponding process cartridges 100, and the first end members 121 and second end members 122 respectively contact with opposite side walls of corresponding process cartridges 100. When adaptation devices are used to transmit power to imaging components of process cartridges 100, one of the process cartridges 100 may be electrically connected to an electrical connection part on the main body side of the image forming device through the input terminal 111 of the electrical transmission component 11 of the corresponding adaptation device 1 to receive external power. At the same time, between two adjacent process cartridges 100, the second end member 122 of an adaptation device 1 corresponding to one of the process cartridges 100 is connected to the first end member 121 of an adaptation device 1 corresponding to the other process cartridge 100, thereby achieving electrical connection between the two adjacent process cartridges 100. Therefore, the number of conductive contacts that need to be provided on the main body side of the image forming device may be reduced. Further, it reduces the force between the main body side of the image forming device and the process cartridge 100, reduces the strength requirements on the main body side of the image forming device, improves the reliability of the structure of the image forming device, and also reduces the cost.

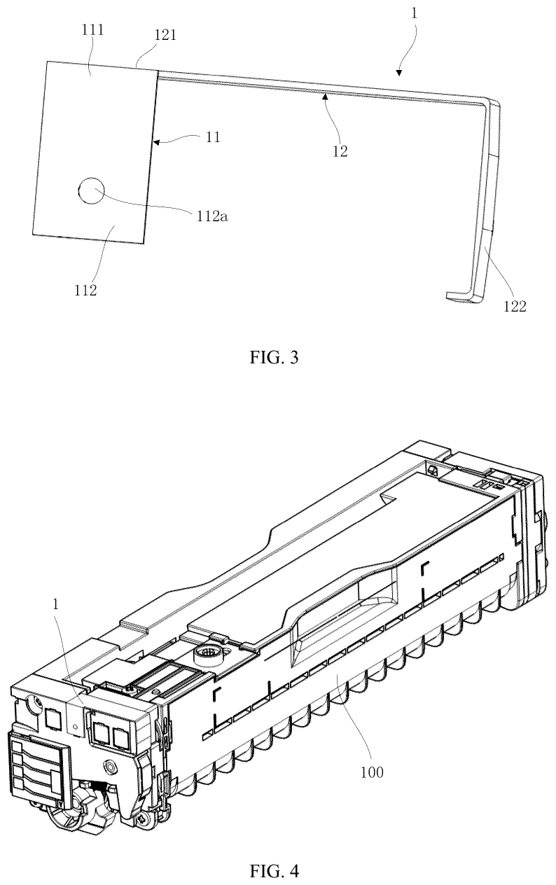

In some embodiments, the input terminal 111 of the electrical transmission component 11 is connected to the first end member 121 of the connection component 12, and only the length extension direction of the second end member 122 is perpendicular to the length extension direction of the connection member 123, as shown in FIGS. 3 and 4. When the adaptation device 1 is installed at the process cartridge 100, the output terminal 112 of the electrical transmission component 11 is connected to the imaging component of a corresponding process cartridge 100. At least a part of the first end member 121 is located on the end surface of the corresponding process cartridge 100, electrically connecting to the electrical contact part on the main body side of the image forming device through the first end member 121 to access an external power supply. The second end member 122 is in contact with the side wall of the process cartridge 100 to deliver power to process cartridges other than the current process cartridge 100 through the second end member 122.

Based on the above embodiments, embodiments of the present application also disclose an imaging module. The imaging module is applied to a process cartridge and includes an imaging component and an adaptation device as described in any of the above embodiments that is electrically connected to the imaging component. The imaging component may be one of the photosensitive drum, the developing roller, and the charging roller at the process cartridge. The axes of the photosensitive drum, the developing roller, and the charging roller are parallel to each other.

Based on the above embodiments, embodiments of the present application also disclose a process cartridge. The process cartridge 100 includes a case and an imaging component. The imaging component is installed between two oppositely arranged end surfaces of the case along the length extension direction of the case (i.e., the X direction in FIG. 2). The case includes an installation area, and the installation area is used to install an adaptation device as described in the above embodiments.

In this embodiment, the process cartridge 100 further includes a conductive sheet. The conductive sheet is electrically connected to an end part of the imaging component. The conductive sheet is used to electrically connect the output terminal 112 of the electrical transmission component 11 to receive the power transmitted by the adaptation device 1 to the imaging component through the conductive sheet. It will be appreciated that in other embodiments, the end part of the imaging component protrudes beyond the outer surface of the case. When the adaptation device is installed in an installation area of the case, the end part of the imaging component may be directly electrically connected to the output terminal of the electrical transmission component.

In order to facilitate the connection between the output terminal 112 of the electrical transmission component 11 and the imaging component, the output terminal 112 of the electrical transmission component 11 is also provided with an accommodation part. The accommodating part is set as a through hole 112a. When the adaptation device 1 is mounted in the installation area of the process cartridge 100, an end part of the imaging component passes through the through hole 112a, so that the output terminal 112 of the adaptation 1 is electrically connected to the imaging component of the process cartridge 100.

In some embodiments, when the adaptation device 1 is installed in the installation area of the process cartridge, the first end member 121 and second end member 122 of the adaptation device 1 are respectively in contact with the opposite side walls of the process cartridge 100. At this time, the imaging component at the process cartridge may receive the power transmitted from the main body side of the image forming device through the input terminal 111 of the electrical transmission component 11. Imaging components of two adjacent process cartridges may be electrically connected through the first end member 121 and second end member 122.

In some embodiments, when the adaptation device 1 is installed in the installation area of the process cartridge, at least a part of the first end member 121 is in contact with an end surface of the process cartridge 100, and the second end member 122 is in contact with the side wall of the process cartridge 100. At this time, the imaging component at the process cartridge may receive power transmitted from the main body side of the image forming device through the first end member 121 of the connection component 12, and the second end member 122 may transmit power to the outside of the current process cartridge.

Based on the above embodiments, embodiments of the present application also disclose a process cartridge. The process cartridge 100 includes a case and an imaging component. The imaging component is installed between two opposite end surfaces of the case along the length extension direction of the case. The end part of the imaging component is electrically connected to the output terminal of the adaptation device as described in the above embodiments.

In this embodiment, the process cartridge 100 further includes a conductive sheet. The two ends of the conductive sheet are electrically connected to the output terminal 112 of the adaptation device 1 and an end part of the imaging component, respectively, so as to receive the power transmitted by the adaptation device 1 to the imaging component through the conductive sheet. It can be understood that in other embodiments, the end part of the imaging component protrudes from the outer surface of the case, so that the end part of the imaging component may be directly electrically connected to the output terminal of the electrical transmission component.

In order to facilitate the connection between the output terminal 112 of the electrical transmission component 11 and the imaging component, the output terminal 112 of the electrical transmission component 11 is provided with an accommodation part. The accommodating part is set as a through hole 112a. An end part of the imaging component passes through the through hole, so that the end part of the imaging component is electrically connected to the output terminal 112 of the adaptation device 1.

In some embodiments, the first end member 121 and second end member 122 of the adaptation device 1 are respectively provided on the opposite side walls of the process cartridge 100. At this time, the power transmitted from the main body side of the image forming device may be received through the input terminal 111 of the electrical transmission component 11, and imaging components at two adjacent process cartridges 100 may be electrically connected through the first end member 121 and second end member 122. Alternatively, at least a part of the first end member 121 is provided on the end surface of the process cartridge 100, and the second end member 122 is provided on the side wall of the process cartridge 100. At this time, the power transmitted from the main body side of the image forming device may be received through the first end member 121 of the connection component 12, and the power may be transmitted to the outside of the current process cartridge through the second end member 122.

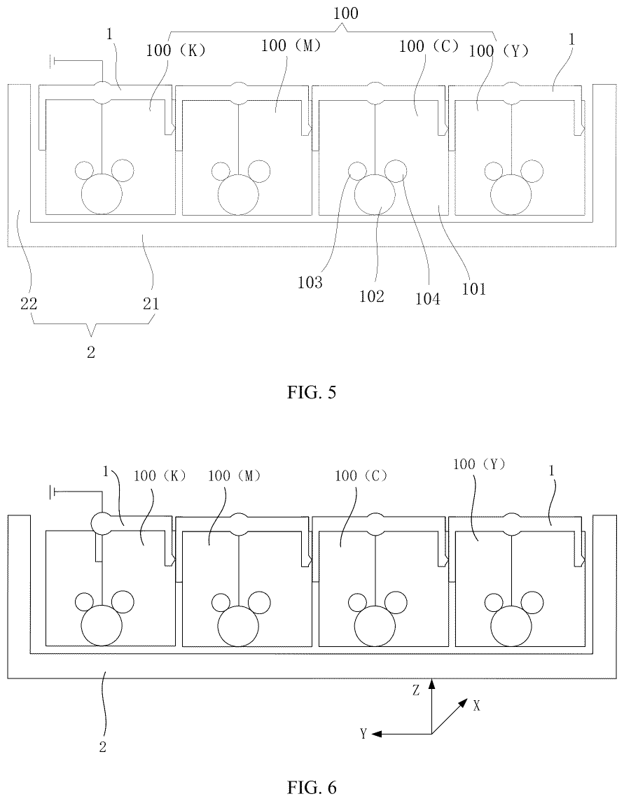

Based on the above embodiments, embodiments of the present application also disclose a process cartridge set. Referring to FIG. 5, the process cartridge set includes process cartridges 100 as described in the above embodiments. Each process cartridge 100 is distributed in a row, and each process cartridge 100 is provided with an adaptation device 1. The imaging component of each process cartridge 100 is connected to an output terminal 112 of a corresponding adaptation device 1. Each process cartridge 100 is provided with a first end member 121 and a second end member 122 on opposite side walls, respectively. Between two adjacent process cartridges 100, the first end member 121 of an adaptation device 1 corresponding to one of the process cartridges 100 is connected to the second end member 122 of an adaptation device 1 corresponding to the other process cartridge 100. Imaging components of the two adjacent process cartridges 100 are electrically connected through the adaptation device 1. Imaging components of at least some of the process cartridges 100 among the process cartridges 100 are electrically connected through the adaptation devices 1. At this time, the input terminal 111 of an electrical transmission component 11 of an adaptation device 1 corresponding to one of the process cartridges 100 is used to electrically connect with an image forming device. The electrical connection with the image forming device is used to receive voltage output from the image forming device, transmitting the voltage output to an imaging component of a corresponding process cartridge 100 and other adaptation device 1, and then transmitting the voltage output to imaging components of other process cartridges 100.

Specifically, toner colors in multiple process cartridges 100 may be the same or different. For example, the process cartridges 100 may include a first process cartridge 100(K), a second process cartridge 100(M), a third process cartridge 100(C), and a fourth process cartridge 100(Y). K, M, C, Y may represent the toner color. Exemplarily, each process cartridge 100 may store a toner of a different color. In this way, the image forming device may form either a black image or a color image on paper.

Each process cartridge 100 includes a case 101, a photosensitive drum 102, a charging roller 103, a developing roller 104, and other components. The photosensitive drum 102, charging roller 103, and developing roller 104 are respectively installed at the case 101. The axial directions of the photosensitive drum 102, charging roller 103, and the developing roller 104 are parallel to the length extension direction of the case 101. The photosensitive drum 102, charging roller 103, and developing roller 104 may all be referred to as imaging components. Detailed description will be described below where the imaging component is the photosensitive drum 102 exemplarily.

In order to facilitate simultaneous disassembly and assembly of multiple process cartridges 100, such as the first process cartridge 100(K), second process cartridge 100(M), third process cartridge 100(C), and fourth process cartridge 100(Y), in some embodiments, the process cartridge set also includes a moving part 2. The moving part 2 may be movably installed in the body of the image forming device and used to accommodate the first process cartridge 100(K), second process cartridge 100(M), third process cartridge 100(C), and fourth process cartridge. When the moving part 2 is located outside the body of the image forming device, the process cartridges 100 may be removed from the moving part 2. That is to say, a user may push and pull the moving part 2 to move multiple process cartridges 100 at the same time, which makes disassembly and assembly more convenient.

The moving part 2 may be a rod-shaped or plate-shaped structural member. In some embodiments, the moving part 2 includes a bottom plate 21 and a side plate 22. The bottom plate 21 and side plate 22 are connected to form a cavity with an opening. The bottom plate 21 is used to support process cartridges such as the first process cartridge 100 (K), the second process cartridge 100 (M), the third process cartridge 100 (C), and the fourth process cartridge 100 (Y). The side plate 22 is arranged around the outsides of the process cartridges 100 and used to limit the positions of each process cartridge 100 so that each process cartridge 100 may be stably installed on the moving part 2.

In some embodiments, a snap groove may be provided on the side plate 22 for locking each process cartridge 100. In this way, each process cartridge 100 is relatively fixed to the moving part, and each process cartridge 100 is prevented from being displaced relative to the moving part 2.

In this embodiment, the number of the adaptation device 1 is set corresponding to the number of process cartridge 100, and each adaptation device 1 is respectively arranged at each process cartridge 100. The adaptation devices 1 are connected end to end (e.g., connected one by one in series), so that the imaging components of each process cartridge 100 are electrically connected through the adaptation device 1.

In actual application scenarios, when the entire process cartridge set is pushed into an image forming device, the input terminal 111 of an electrical transmission component 11 of an adaptation device 1 corresponding to one of the process cartridges 100 is in contact with a high-voltage contact on the main body side of the image forming device to conduct voltage. At this time, under the action of the adaptation device 1, the high voltage on the main body of the image forming device is transmitted to an imaging component inside the process cartridge 100 in the longitudinal direction, and the high voltage on the main body of the image forming device is transmitted to the remaining three series-connected process cartridges 100 in the lateral direction. It is not necessary for the imaging components on each process cartridge 100 to be in direct contact with high-voltage contacts on the main body of the image forming device. It reduces the number of high-voltage contacts provided on the main body side of the image forming device, and realizes the function of simultaneously conducting imaging components of the four process cartridges 100 by one high-voltage contact provided on the main body side of the image forming device.

In this embodiment, four process cartridges 100 with identical structures are connected through the adaptation device 1 to realize mutual electrical connection among the four process cartridges 100. There is no need to design a structure separately for the process cartridge 100 of each color, which reduces the design difficulty and also reduces product development and production costs.

In this embodiment, the imaging component is the photosensitive drum. It can be understood that in other embodiments, the imaging component may also be a developing roller or a charging roller, etc. Of course, the number of imaging component is not limited to one, and may also be two or more. Specifically, different imaging components need to be provided with corresponding adaptation devices. For example, if the number of imaging component is two, which are the photosensitive drum and developing roller, two adaptation devices need to be provided, which are a first adaptation device and a second adaptation device. The photosensitive drum of each process cartridge is electrically connected to the first adaptation device, and the charging roller of each process cartridge is electrically connected to the second adaptation device.

Based on the above embodiments, the present application also discloses another specific implementation of a process cartridge set. The difference between this embodiment and the above-mentioned embodiment is that, with reference to FIG. 6, in this embodiment, along the arrangement direction of the process cartridges 100 (i.e., the Y direction in FIG. 6), the first end member 121 of the adaptation device 1 corresponding to the first process cartridge 100 does not extend along the height extension direction of the process cartridges (i.e., the Z direction in FIG. 6).

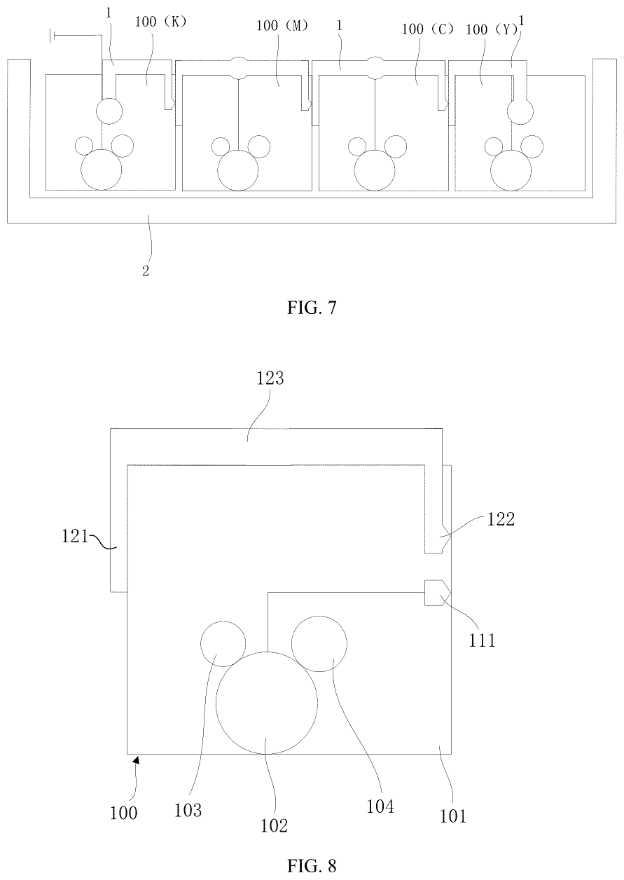

In some embodiments, referring to FIG. 7, along the arrangement direction of the process cartridges 100, the first end member 121 of an adaptation device 1 corresponding to the first process cartridge 100 does not extend along the height extension direction of the process cartridge, and the second end member of the adaptation device 1 corresponding to the fourth process cartridge 100 does not extend along the height extension direction of the process cartridge.

When receiving power, the first end member 121 of an adaptation device 1 corresponding to the first process cartridge 100 is electrically connected to the image forming device. Moreover, the process cartridges 100 are also electrically connected with each other through the first end members 121 and second end members 122 of the adaptation devices 1. As such, the voltage output from the image forming device is received through the adaptation device 1 corresponding to the first process cartridge 100. The received voltage is transmitted to the imaging component of the first process cartridge 100 and imaging components of other process cartridges 100.

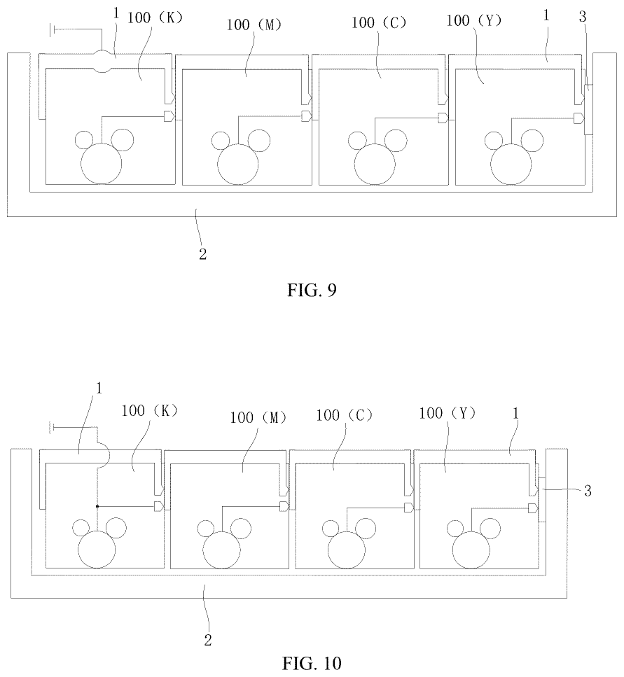

Based on the above embodiments, the present application also discloses another specific implementation of a process cartridge set. The difference between this embodiment and the above-mentioned embodiments is that, as shown in FIGS. 8 and 9, in this embodiment, the electrical transmission component 11 and the connection component 12 are not directly electrically connected. The input terminal 111 of the electrical transmission component 11 is spaced apart from the second end member 122 of the connection component 12. For example, the input terminal 111 of the electrical transmission component 11 and the second end member 122 of the connection component 12 are arranged in parallel. When an adaptation device is used to transmit power to an imaging component at the process cartridge, the input terminal 111 of the electrical transmission component 11 is electrically connected to at least one of the first end member 121 and second end member 122. When multiple process cartridges 100 are installed in the image forming device, two adjacent process cartridges 100 are electrically connected. At this time, the second end member 122 and the input terminal 111 of an adaptation device 1 corresponding to one of the process cartridges 100 are electrically connected to the first end member 121 of an adaptation device 1 corresponding to another process cartridge 100 at the same time. It achieves electrical connection between the imaging components of each process cartridge 100.

In some embodiments, the moving part 2 is provided with a conductive connector 3. When each process cartridge 100 is installed on the moving part 2, the second end member 122 of an adaptation device 1 corresponding to a process cartridge 100 located at the edge is electrically connected to the input terminal 111 of a corresponding adaptation device 1 through the conductive connector 3. As such, imaging components of each process cartridge may obtain voltage.

In this embodiment, the connection component 12 of an adaptation device 1 corresponding to the first process cartridge 100 is electrically connected to an image forming device. It can be understood that in other embodiments, the electrical transmission component 11 of an adaptation device 1 corresponding to the first process cartridge 100 may be electrically connected to the image forming device, as shown in FIG. 10.

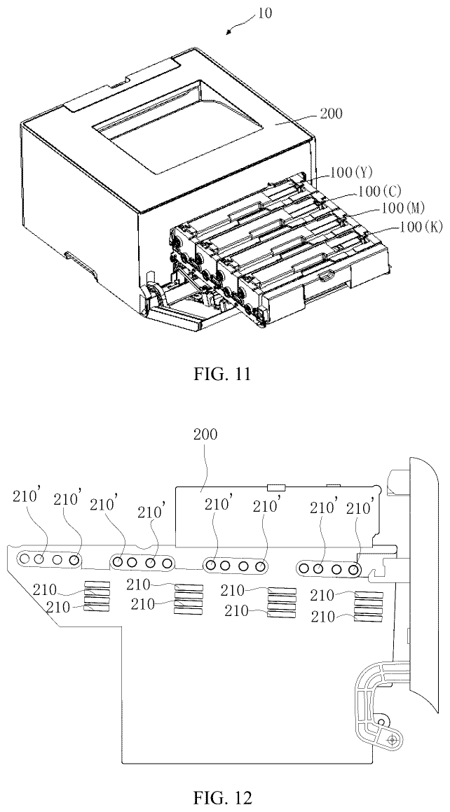

Based on the above embodiments, this embodiment also discloses an image forming device 10. The image forming device 10 may be a laser printer, a laser copier, etc. Referring to FIG. 11, the image forming device includes a body 200 and a process cartridge set as described in any of the above embodiments. The process cartridge set is detachably installed at the body 200 of the image forming device.

Specifically, the image forming device 10 also includes an optical scanning unit (not shown), a paper feeding unit (not shown), a fixing unit (not shown), a process cartridge set described below and so on that are provided on the body 200. The working principle and process of the image forming device 10 are as follows: the optical scanning unit performs exposure at the process cartridge to convert the image information into a latent electrostatic image; the process cartridge converts the electrostatic latent image into a toner image; the paper feeding unit transports the paper to the process cartridge position so that the toner image is transferred to the paper. Then, the paper feeding unit transports the paper to a fixing unit, which fixes the toner image on the paper through heating and pressure. Then, the paper feeding unit outputs the paper to the outside of the image forming device 10.

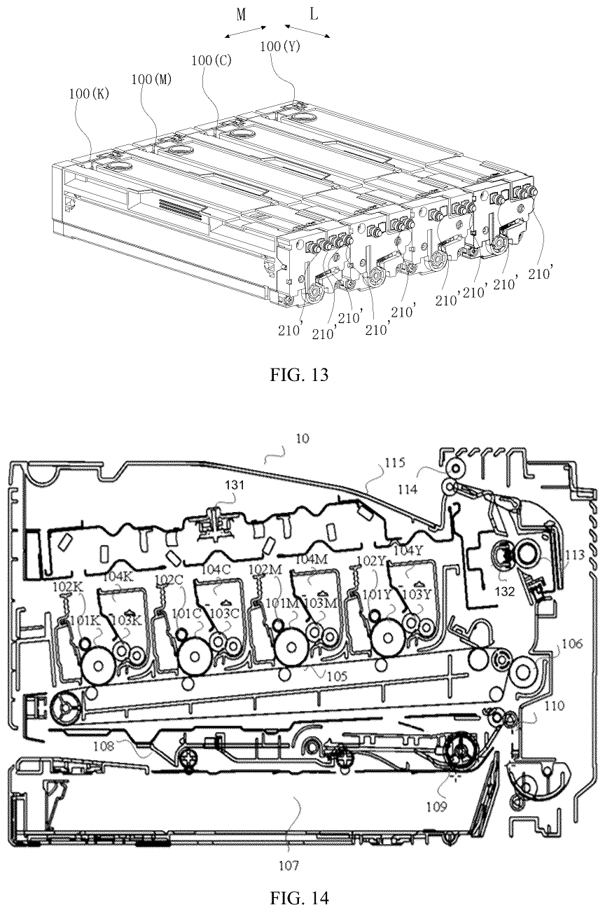

Referring to FIGS. 12 and 13, the body 200 is provided with a first conductive terminal 210 and a second conductive terminal 210′. The first conductive terminal 210 is used for electrical connection with a storage device of the process cartridge. The second conductive terminal 210′ is used for connection with conductive components of the process cartridge to electrically connect the imaging component and external conductive members. The second conductive terminal 210′ on the main body side may be called an external conductive member. It can be understood that the second conductive terminal 210′ on the main body side may be considered as an electrical connection structure connected to the conductive component, and is not limited to the contact position with the conductive component.

Based on the above embodiments, the present application also discloses another image forming device. The image forming device is a color laser printer. Referring to FIG. 14, the image forming device 10 includes a process cartridge set described in any of the above embodiments, a transfer belt 105, a secondary transfer roller 106, an input paper box 107, a manual paper feed tray 108, a paper feed roller 109, a conveying roller 110, a laser scanning unit (LSU) 131, a heat roller 132, a pressure roller 113, a discharge roller 114, a discharge paper box 115, etc. The process cartridge set includes four process cartridges. Each process cartridge includes photosensitive drums 101Y-101K, charging rollers 102Y-102K, developing rollers 103Y-103K, and toner bins 104Y-104K for holding toner.

The laser scanning unit (LSU) 131 is in the form of a single LSU and includes four optical beam paths. The four charging rollers 102Y-102K are used to charge the surface of the four photosensitive drums 101Y-101K, respectively. Along the four optical paths of the laser scanning unit, laser beams are emitted respectively to form latent electrostatic images on the surface of the photosensitive drums 101Y-101K. The four developing rollers 103Y-103K are used to develop toner images of one color on the surface of the photosensitive drums 101Y-101K, respectively. The image forming device 10 adopts a secondary transfer method. That is, the four photosensitive drums 101Y-101K sequentially transfer toner images to the transfer belt 105, and then the color toner image formed on the transfer belt 105 is secondarily transferred to the paper through the secondary transfer roller 106. The paper enters the paper tray 107 for storing paper. The paper feed roller 109 is used to convey the stored paper to a conveyance path. The conveying roller 110 is used to convey the paper to the secondary transfer roller 106.

The secondary transfer roller 106 transports the imaged paper to a nip area between the heat roller 132 and the pressure roller 113. The heat roller 132 and the pressure roller 113 are used to fix the toner image on the paper. The heat roller 132 may adopt a ceramic heating method. The heat roller 132 and pressure roller 113 transport the fixed paper to the discharge roller 114, and the discharge roller 114 discharges the paper to the discharge paper box 115 and stacks it.

The above are only the preferred specific implementation modes of the present application. However, the protection scope of this application is not limited to this. Any changes or substitutions that can be easily imagined by those skilled in the art within the technical scope disclosed in this application should be covered by the protection scope of this application. Therefore, the protection scope of this application should be subject to the protection scope of the claims.

The last thing to note is: the above embodiments are only used to illustrate the technical solution of the present application, but are not intended to limit it; although the present application has been described in detail with reference to the foregoing embodiments, those of ordinary skill in the art will understand that: it is still possible to modify the technical solutions recorded in the foregoing embodiments, or to make equivalent replacements for some or all of the technical features; however, these modifications or substitutions do not cause the essence of the corresponding technical solution to depart from the scope of the technical solution of each embodiment of the present application.

What is claimed is:

1. An adaptation device detachably installed at the process cartridge, the adaptation device comprising:
an electrical transmission component, wherein the electrical transmission component includes an input terminal and an output terminal, the input terminal is electrically connected to the output terminal, and the output terminal is used to supply power to an imaging component of the process cartridge; and
a connection component, wherein the connection component includes a first end member and a second end member, the first end member is electrically connected to the second end member, the second end member is used to output power, at least one of the first end member and the input terminal is used to connect to an external power supply, and the input terminal of the electrical transmission component is electrically connected to at least one of the first end member and the second end member when the adaptation device is used to transmit power to the imaging component at the process cartridge.

2. The adaptation device according to claim 1, wherein when the adaptation device is installed at the process cartridge, a shortest connection line between the first end member and the second end member is parallel to a width extension direction of the process cartridge.

3. The adaptation device according to claim 1, wherein a length extension direction of the electrical transmission component is perpendicular to a length extension direction of the connection component.

4. The adaptation device according to claim 1, further comprising:
a fixing part, the electrical transmission component detachably connected to the connection component through the fixing part.

5. The adaptation device according to claim 1, wherein the electrical transmission component and the connection component are integrally formed.

6. The adaptation device according to claim 1, wherein the connection component further includes a connection member, two ends of the connection member are connected to the first end member and the second end member, respectively, a length extension direction of at least one of the first end member and the second end member is perpendicular to a length extension direction of the connection member, and when the adaptation device is installed at the process cartridge, at least one of the first end member and the second end member extends along a direction perpendicular to a width extension of the process cartridge.

7. The adaptation device according to claim 1, wherein the output terminal is provided with an accommodation part, the accommodation part is used to accommodate the imaging component, so that the electrical transmission component is electrically connected to the imaging component.

8. The adaptation device according to claim 7, wherein the accommodation part is configured as a through hole, and the through hole is used to be sleeved on the imaging component.

9. The adaptation device according to claim 1, wherein the output terminal of the electrical transmission component is used to electrically connect with a conductive sheet of the process cartridge to electrically connect an end part of the imaging component.

10. The adaptation device according to claim 1, wherein when the adaptation device is used to transmit power to the imaging component at the process cartridge, and electrically connect an electrical connection part on a main body side of an image forming device through the input terminal of the electrical transmission component to access the external power supply, the first end member and the second end member are respectively in contact with opposite side walls of the process cartridge.

11. The adaptation device according to claim 1, wherein when the adaptation device is used to transmit power to the imaging component at the process cartridge, and electrically connect an electrical contact part on a main body side of an image forming device through the first end member of the connection component to access the external power supply, at least a part of the first end member is in contact with an end surface of the process cartridge, and the second end member is in contact with a side wall of the process cartridge.

12. A process cartridge, comprising:
a case; and
an imaging component installed at the case, wherein the imaging component is installed between two oppositely arranged end surfaces of the case along a length extension direction of the case, the case includes an installation area, the installation area is used to install an adaptation device, and the adaptation device comprises:
an electrical transmission component, wherein the electrical transmission component includes an input terminal and an output terminal, the input terminal is electrically connected to the output terminal, and the output terminal is used to supply power to the imaging component; and
a connection component, wherein the connection component includes a first end member and a second end member, the first end member is electrically connected to the second end member, the second end member is used to output power, at least one of the first end member and the input terminal is used to connect to an external power supply, and the input terminal of the electrical transmission component is electrically connected to at least one of the first end member and the second end member when the adaptation device is used to transmit power to the imaging component at the process cartridge.

13. The process cartridge according to claim 12, further comprising:
a conductive sheet, wherein the conductive sheet is connected to an end part of the imaging component, the conductive sheet is used to electrically connect with an output terminal of an electrical transmission component to receive power provided to the imaging component.

14. The process cartridge according to claim 12, wherein an end part of the imaging component protrudes beyond an outer surface of the case, and when the adaptation device is installed in the installation area of the case, the end part of the imaging component is electrically connected to an output terminal of an electrical transmission component.

15. The process cartridge according to claim 14, wherein the output terminal of the electrical transmission component is provided with an accommodation part, and when the adaptation device is installed in the installation area, the end part of the imaging component is electrically connected to the accommodation part.

16. The process cartridge according to claim 15, wherein the accommodation part is arranged as a through hole, and when the adaptation device is installed in the installation area, the end part of the imaging component passes through the through hole.

17. The process cartridge according to claim 12, wherein when the adaptation device is installed in the installation area, the imaging component at the process cartridge receives power through the adaptation device, and a first end member and a second end member of the adaptation device are respectively in contact with opposite side walls of the process cartridge.

18. The process cartridge according to claim 12, wherein when the adaptation device is installed in the installation area, the imaging component at the process cartridge receives power transmitted from a main body side of an image forming device through a first end member of the connection component, at least a part of the first end member contacts an end surface of the process cartridge, and a second end member contacts a side wall of the process cartridge.

19. A process cartridge set, comprising:
a first process cartridge; and
a second process cartridge, wherein each of the first process cartridge and second process cartridge comprises:
a case; and
an imaging component installed at the case, wherein the imaging component is installed between two oppositely arranged end surfaces of the case along a length extension direction of the case, the case includes an installation area, the installation area is used to install an adaptation device, and the adaptation device comprises:
an electrical transmission component, wherein the electrical transmission component includes an input terminal and an output terminal, the input terminal is electrically connected to the output terminal, and the output terminal is used to supply power to the imaging component; and
a connection component, wherein the connection component includes a first end member and a second end member, the first end member is electrically connected to the second end member, the second end member is used to output power, at least one of the first end member and the input terminal is used to connect to an external power supply, the input terminal of the electrical transmission component is electrically connected to at least one of the first end member and the second end member when the adaptation device is used to transmit power to the imaging component at the process cartridge, and the adaptation device is installed in the installation area;
wherein at the first process cartridge, the imaging component receives power through the adaptation device, and the first end member and second end member of the adaptation device are respectively in contact with opposite side walls of the process cartridge; and
wherein at the second process cartridge, the imaging component receives power transmitted from a main body side of an image forming device through the first end member of the connection component, at least a part of the first end member contacts an end surface of the process cartridge, and the second end member contacts a side wall of the process cartridge.

20. The process cartridge set according to claim 19, wherein when the process cartridge set is installed at the image forming device, the first and second process cartridges are distributed in a row, each of the first or second process cartridge is provided with a corresponding adaptation device, and imaging components of the first and second process cartridges are connected through corresponding adaptation devices.
